(19) United States
(12) Patent Application Publication
(10) Pub. No.: US 2003/0107211 A1
(43) Pub. Date: Jun. 12, 2003

(54) Combination calander and advertising format

(76) Inventor: Jhong Uhk Kim, Staten Island, NY (US)

Correspondence Address: SALVATORE C. MITRI, 263 Bryant Avenue, Staten Island, NY, 10306, US

(21) Appl. No.: 10/014,673

(22) Filed: Dec. 11, 2001

(51) Int. Cl. B42D 5/04; B32B 3/00; B32B 27/14

(52) U.S. Cl. 283/2

(57) ABSTRACT

There is disclosed a combination calendar and advertising format composed of a plurality of generally elongated rectangular sheets joined together at their tops. Each sheet is divided into transversely defined panels and each panel contains a different monthly calendar and a combination of printed commercial and personal advertising matter and graphics. A sufficient number of sheets are provided so that the different monthly calendars span at least one calendar year.

### FIELD OF THE INVENTION

This invention is directed to a calendar and advertising format. More particularly, this invention is directed to a format that contains graphic, printed, artistic and photographic advertising matter combined with monthly calendars spanning a calendar year.

### BACKGROUND OF THE INVENTION

Monthly calendars containing advertising matter are known. These calendars are generally provided in the form of a plurality of single pages, each page containing the calendar for a single month and which can include a few lines of printed advertising matter to identify the donor. When one month ends, the page containing that month can be either turned over or torn off and discarded to expose the calendar for the next month which contains the same printed advertising matter.

Another type of known calendar is also provided in the form of single pages with each page containing the calendar for a single month and a few lines of printed matter to identify the donor. The reverse side of the page containing the calendar can contain additional printed advertising matter or an artistic rendering, a reproduction of art, a photograph, and the like. The pages are normally joined together so that when the calendar page is turned, there is exposed both the reverse side of the calendar page and the page containing the next calendar month.

These types of calendar formats are limiting since they typically display only a single advertisement, artistic rendering, reproduction of art, photograph, and the like, with a single exposed calendar month.

### SUMMARY OF THE INVENTION

The combination calendar and advertising format of this invention generally comprises: a plurality of sheets of printable stock paper; a plurality of panels transversely defined on each of said sheets; a plurality of printed matter and graphics contained on the upper face of each of said panels; and, a monthly calendar contained on at least one of said panels.

In one embodiment, the sheets are joined together at one end and are provided with means to vertically suspend the format for display.

In another embodiment, each of the panels contains a monthly calendar as well as printed matter and graphics.

In a further embodiment, the printed matter can include commercial and/or personal advertising copy such as business advertisements promoting clothing, food, products, services, and the like, as well as events, messages, quotations, slogans, and the like.

In still another embodiment, the graphics can include artistic renderings, art reproductions, photographs, trademarks, service marks, and the like.

### BRIEF DESCRIPTION OF THE DRAWING

The combination calendar and advertising format of the invention is further illustrated in the accompanying drawing wherein:

FIG. 1 is a perspective view of a typical prior art calendar;

FIG. 2 is a side view of a partially expanded combined calendar and advertising format of the invention;

FIG. 3 is a plan view of the combined calendar and advertising format of the invention; and,

FIG. 4 is an exaggerated plan view illustrating a typical panel of the combined calendar and advertising format of the invention.

### DETAILED DESCRIPTION OF THE DRAWINGS AND THE INVENTION

The combined calendar and advertising format of the invention will become more apparent from the ensuing description when considered together with the accompanying drawing wherein like reference numerals and letters denote like parts.

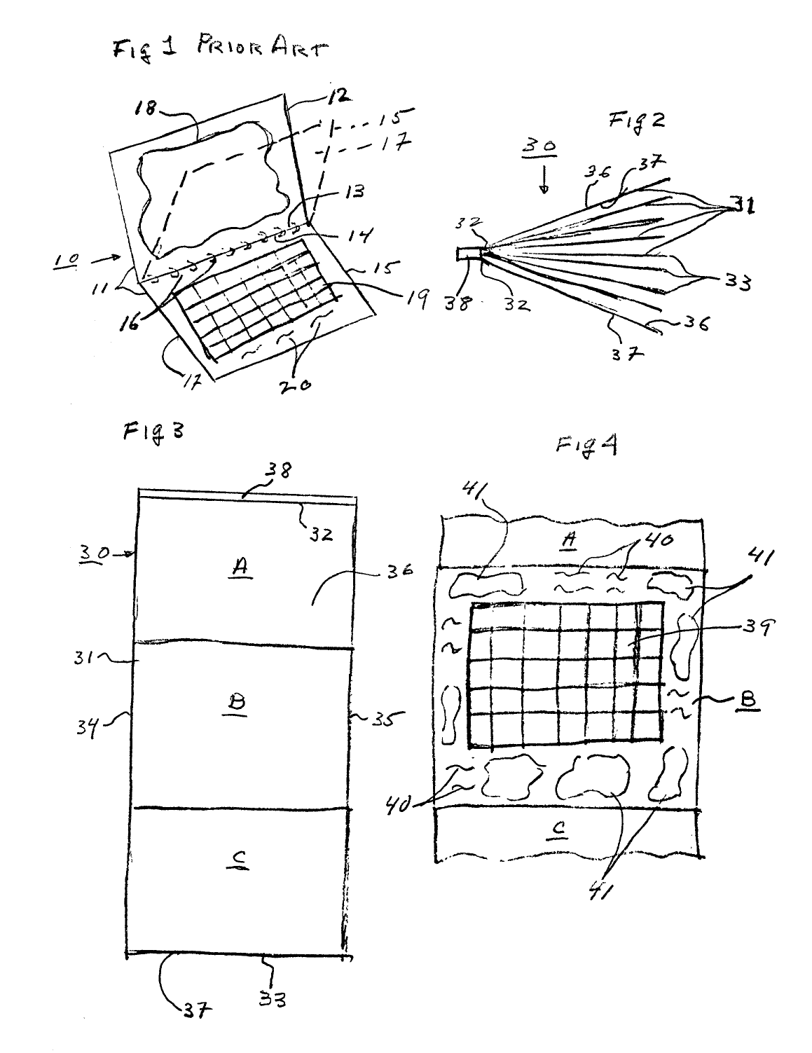

FIG. 1 depicts a typical prior art calendar, generally identified by reference numeral 10, made up of separate sheets of printable paper 11 with the bottom 13 of the top sheets 12 joined to the top 14 of the next, succeeding sheets 15 such as by use of spiral connectors 16. The top sheets 12 are generally the reverse sides 17 of the next, succeeding sheets 15 and typically contain graphics such as artistic illustrations such as familiar street scenes, art reproductions such as religious compositions, landscapes, and the like, photographic reproductions such as animals and animal groupings, landscapes, seascapes, and the like, indicated by free form outline 18. The exposed succeeding sheets 15 typically contain a current monthly calendar 19 and can include printed matter such as advertising identifying the donor such as, for example, a business such as a funeral home, a plumber, and the like, or services such as accountants, a house of worship, legal groups, medical groups, and the like, as indicated by wavy lines 20.

FIGS. 2, 3 and 4 illustrate a preferred embodiment of the combined calendar and advertising format of the invention. As can be seen in FIGS. 2 and 3, the combined calendar and advertising format of the invention, generally identified by reference numeral 30, is composed of a plurality of separate, elongated, generally rectangular shaped sheets 31 of printable stock, each sheet having a top 32, a bottom 33, opposed sides 34 and 35, an upper face 36 and a reverse face 37. The printable stock that can be used is one that is commercially available and that will readily accept printed matter and/or graphics. The printable stock can be from about 20 pound weight to about 40 pound weight and can be finished, glossy, matte or unfinished provided that it is capable of accepting printed matter and/or graphics.

The plurality of sheets 31 are preferably joined together at one end such as at their tops 32 by conventional means such as adhesives, staples, a tape binding, or the like as indicated at 38 and can be provided with means such as a hook, string, and the like (not shown) so that the format can be suspended for display against a flat, vertical surface such as a wall, door, and the like. The sheets are preferably joined together so that the uppermost sheet can be torn off to expose the next succeeding sheet.

Each sheet is divided into a plurality of transversely defined panels, all of which contain printed matter, graphics or combinations of printed matter and graphics. Preferably, each sheet is divided into three such panels, A, B and C (FIG. 3) with at least one of the panels containing a monthly calendar. More preferably, each of the three panels contains a monthly calendar; namely, a calendar for a prior month, a calendar for the current month and a calendar for the next month, as well as printed matter and graphics. Depending upon the number of panels that each sheet is divided into, a sufficient number of sheets are provided so that the monthly calendars contained on the sheets collectively span a calendar year.

FIG. 4 illustrates a typical panel, such as panel B (FIG. 3) of the combined calendar and advertising format of the invention. As can be seen, this panel, B, contains a calendar 39 and a combination of printed matter shown by wavy lines 40 and graphics shown by a free form outlines 41.

As stated above, illustrative printed matter that can be contained on the panels of the invention format can include commercial and/or personal advertising copy such items as business advertisements promoting clothing, food, products, services, and the like, as well as events, messages, quotations, slogans, and the like. Similarly, illustrative of the graphic matter that can be contained on the panels of the invention format are such items as artistic renderings, art reproductions, photographs, trademarks, service marks, and the like.

In a most preferred embodiment, the printed matter contained on the panels of the invention format is in the form of commercial advertising identifying dining and eating establishments such as catering halls, fast food chains, restaurants, and the like, and the graphic matter contained on the panels of the invention format is in the form of artistic renderings and photographs depicting foods, meals, prepared dishes, and the like.

Although the invention has been described with reference to preferred embodiments as well as with particularity and in some detail, it will be appreciated by those skilled in the art that the preferred embodiments are illustrative of and not limitative of the invention and that changes and modifications can be made therein without departing from the scope and spirit of the invention.

What is claimed:

1. A combined calendar and advertising format comprising:
(a) a plurality of sheets of printable stock, each sheet having a top, a bottom, opposed sides, a upper face and a reverse face;
(b) a plurality of transversely defined panels on each of said sheets;
(c) a plurality of printed matter and graphics contained on each of said panels; and,
(d) at least one monthly calendar contained on one of said panels.

2. The format of claim 1 wherein said printable stock is from about 20 pound weight to about 40 pound weight.

3. The format of claim 1 wherein said printed matter is commercial and personal advertising copy and combinations thereof and said graphics are selected from the group consisting of artistic renderings, art reproductions, photographs, trademarks, service marks, and combinations thereof.

4. The format of claim 3 wherein said printed matter is in the form of commercial advertising identifying dining and eating establishments selected from the group consisting of catering halls, fast food chains, restaurants and combinations thereof and said graphics are in the form of artistic renderings and photographs selected from the group consisting of foods, meals, prepared dishes and combinations thereof.

5. The format of claim 1 wherein each of said panels contains a different monthly calendar.

6. The format of claim 5 wherein a sufficient number of said sheets is provided so that said monthly calendars collectively span a calendar year.

7. The format of claim 1 wherein said sheets are joined together at their tops.

8. The format of claim 1 wherein three transversely defined panels are contained on each of said sheets.

9. The format of claim 8 wherein each of said panels contains a different monthly calendar, printed matter and graphics.

10. A combined calendar and advertising format comprising:
(a) a plurality of sheets of printable stock, each sheet having a top, a bottom, opposed sides, an upper face and a reverse face, the upper face of each of said sheets being divided into three transversely defined panels;
(b) a plurality of printed matter and graphics contained on each of said panels;
(c) a different monthly calendar contained on each of said panels; and,
(d) means to join said sheets together at their tops.

11. The format of claim 10 wherein said printable stock is from about 20 pound weight to about 40 pound weight.

12. The format of claim 10 wherein said printed matter is commercial and personal advertising copy and combinations thereof and said graphics are selected from the group consisting of artistic renderings, art reproductions, photographs, trademarks, service marks, and combinations thereof.

13. The format of claim 12 wherein said printed matter is in the form of commercial advertising identifying dining and eating establishments selected from the group consisting of catering halls, fast food chains, restaurants, and combinations thereof and said graphics are in the form of artistic renderings and photographs selected from the group consisting of foods, meals, prepared dishes and combinations thereof.

14. The format of claim 12 wherein a sufficient number of said sheets are provided so that said monthly calendars collectively span a calendar year.

15. A combined calendar and advertising format comprising:
(a) a plurality of sheets of printable stock, each sheet having a top, a bottom, opposed sides, an upper face and a reverse face, the upper face of each of said sheets being divided into three transversely defined panels;
(b) a plurality of printed matter and graphics contained on each of said panels;
(c) a different monthly calendar contained on each of said panels, said sheets being sufficient in number such that said monthly calendars collectively span a calendar year; and,
(d) means to join said sheets together at their tops.

16. The format of claim 15 wherein said printable stock is from about 20 pound weight to about 40 pound weight.

17. The format of claim 15 wherein said printed matter is commercial and personal advertising copy and combinations thereof and said graphics are selected from the group consisting of artistic renderings, art reproductions, photographs, trademarks, service marks, and combinations thereof.

18. The format of claim 17 wherein said printed matter is in the form of commercial advertising identifying dining and eating establishments selected from the group consisting of catering halls, fast food chains, restaurants and combinations thereof and said graphics are in the form of artistic renderings and photographs selected from the group consisting of foods, meals, prepared dishes and combinations thereof.
